(19) United States
(12) Patent Application Publication
(10) Pub. No.: US 2024/0061188 A1
(43) Pub. Date: Feb. 22, 2024

(54) CYLINDRICAL MULTI-CORE FERRULE AND OPTICAL CONNECTOR

(71) Applicant: NIPPON TELEGRAPH AND TELEPHONE CORPORATION, Tokyo (JP)

(72) Inventors: Chisato FUKAI, Musashino-shi, Tokyo (JP); Yoshiteru ABE, Musashino-shi, Tokyo (JP); Kunihiro TOGE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/270,911

(22) PCT Filed: Jan. 20, 2021
(86) PCT No.: PCT/JP2021/001779

§ 371 Date: Jul. 5, 2023

(51) Int. Cl. G02B 6/38; G02B 6/40

(52) U.S. Cl. CPC G02B 6/3885; G02B 6/403

(57) ABSTRACT

An object of the present disclosure is to enable a plurality of single-core fibers to be easily and collectively connected. The present disclosure relates to a cylindrical multi-core ferrule having a cylindrical shape and having through holes formed therein for holding a plurality of optical fibers on the same circle centered on a central axis of the cylindrical shape and an optical connector in which the cylindrical multi-core ferrule are disposed opposite to each other and a gap is formed between end surfaces of an optical fiber held by the cylindrical multi-core ferrule.

### TECHNICAL FIELD

The present disclosure relates to a cylindrical multi-core ferrule used for collectively connecting a plurality of ports using optical fibers in an optical fiber network, and an optical connector using the same.

### BACKGROUND ART

As a technique for connecting a plurality of single mode optical fibers, there is a multi-fiber optical connector (for example, NPL 1). The optical connector can be easily attached and detached in the connection of optical fibers, and is useful for the switching of wiring in a building and the connection to a device requiring to be exchanged every several years. In a general multi-fiber optical connector, two guide holes are provided in a ferrule having a rectangular end surface, and a guide pin is inserted into the guide holes to perform connection. The shaft is adjusted by the guide hole and the guide pin, and a connection loss of 1 dB or less is realized by controlling a clearance between the guide hole and the guide pin. Further, an optical connector in which reflection characteristics are improved by obliquely polishing the ferrule end surface, and convenience is improved by attaching a housing and attaching and detaching the housing by a push-pull mechanism has been developed (for example, NPL 2).

On the other hand, in an optical connector using a cylindrical ferrule which is generally used as a technique for connecting optical fibers, the ferrule is inserted into a sleeve for connection. In general, a split sleeve is used as the sleeve, and the inner diameter of the split sleeve is made smaller than the outer diameter of the ferrule, thereby improving the accuracy of the axis adjustment, and a connection loss of equal to or less than 0.5 dB is realized in a single-core optical connector. As a technique for collectively connecting a plurality of ports of an optical fiber in an optical connector using this cylindrical ferrule, an optical connector using a multi-core fiber (for example, NPL 3) has been examined. Further, an SC type (for example, NPL 4) optical connector having improved shaft rotation accuracy has been examined.

However, in the prior art described in NPL 1 described above, since the fiber positions of each fiber on the ferrule end surface are not constant due to errors in manufacturing processing, it is difficult to make physical contact with all core wires, and reflection characteristics deteriorate. Therefore, it is generally necessary to apply a refractive index matching material and to use an exclusive tool for attachment and detachment, and there is a problem that working processing is complicated.

Further, in the prior art described in NPL 2, it is difficult to control the clearance between the guide hole and the guide pin, and there is a problem that the cost increases in the manufacture of an optical connector having a low loss.

Further, in the prior art described in NPL 3 or NPL 4, it is necessary to use a multi-core fiber for collectively connecting a plurality of ports by using a cylindrical ferrule. However, multicore fibers are expensive. In addition, in wiring between normal transmission and reception devices which are assumed to be connected to a single-core fiber, devices such as fan-in and fan-out must be used, and a wiring configuration becomes complicated.

### CITATION LIST

### Non Patent Literature

[NPL 1] M. Kawase, T. Fuchigami, M. Matsumoto, S. Nagasawa, S. Tomita, and S. Takashima, “Subscriber Single-Mode Optical Fiber Ribbon Cable Technologies Suitable for Mdspan Access”, J. Lightwave Technol., vol. 7, No. 11, pp. 1675-1681, 1989
[NPL 2] M. Kihara, S. Nagasawa, and T. Tanifuji, “Design and Performance of an Angled Physical Contact Type Multifiber Connector,” J. Lightwave Technol., vol. 14, no. 4, pp. 542-548, 1996.
[NPL 3] Katsuyoshi SAKAIME, Ryo NAGASE, Kengo WATANABE, and Tsunetoshi SAITO “Mechanical characteristic of MU-Type MCF connector” IEICE Technical Report, OCS2013-118, pp. 97-100, 2014
[NPL 4] Tetsuya KOBAYASHI, Haruyuki ENDO, and Yosuke MINAGAWA” Study on Multicore Fiber connectors,” IEICE Technical Report, OCS2014-33, pp. 13-16, 2014

### SUMMARY OF INVENTION

### Technical Problem

An object of the present disclosure is to enable a plurality of single-core fibers to be easily and collectively connected.

### Solution to Problem

The cylindrical multi-core ferrule of the present disclosure has a cylindrical shape, and a through hole for holding a plurality of optical fibers is formed on the same circle around a central axis of the cylindrical shape.

The optical connector of the present disclosure has cylindrical multi-core ferrules of the present disclosure disposed opposite to each other, and has a gap between end surfaces of optical fibers held by the cylindrical multi-core ferrules.

### Advantageous Effects of Invention

According to the present disclosure, since a plurality of single-core fibers can be easily and collectively connected, economical optical connection can be realized.

### BRIEF DESCRIPTION OF DRAWINGS

FIG. 1 is a schematic diagram illustrating a cross section of a ferrule according to an embodiment of the present disclosure.

FIG. 2 is a schematic diagram illustrating a side surface of an optical coupling portion according to an embodiment of the present disclosure.

FIG. 3 is a schematic view illustrating the vicinity of a ferrule end surface of an optical coupling portion according to an embodiment of the present disclosure.

FIG. 4 is a diagram illustrating an example of the relationship between an angle of an angle control region with respect to the ferrule flat surface and a return loss.

FIG. 5 is a diagram illustrating an example of the relationship of excessive loss with respect a gap between optical fibers.

FIG. 6 is a diagram illustrating an example of the relationship of ferrule flat surface diameter with respect of a core placement radius.

FIG. 7 is a diagram illustrating an example of the relationship of the number of cores of the optical fiber to the core placement radius.

FIG. 8 is a diagram illustrating an example of the relationship of the excessive loss with respect to a rotational angle deviation.

FIG. 9 is a view illustrating a fitting form of an optical connector according to a first embodiment of the present disclosure.

FIG. 10 is a diagram illustrating an example of a configuration in which a flange is attached to a ferrule.

FIG. 11 is a diagram illustrating an example of a configuration in which a flange is attached to a ferrule.

FIG. 12 is a schematic diagram illustrating a mechanism that enables rotation and fixing of the ferrule inside a plug frame according to the first embodiment of the present disclosure.

FIG. 13 is a schematic diagram illustrating a mechanism that enables rotation and fixing of the ferrule inside the plug frame according to the first embodiment of the present disclosure.

FIG. 14 is a schematic diagram illustrating a mechanism that enables rotation and fixing of the ferrule inside a plug frame according to a second embodiment of the present disclosure.

### DESCRIPTION OF EMBODIMENTS

Embodiments of the present disclosure will be described in detail below with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

The following describes an embodiment of the present disclose in detail with reference to the drawings.

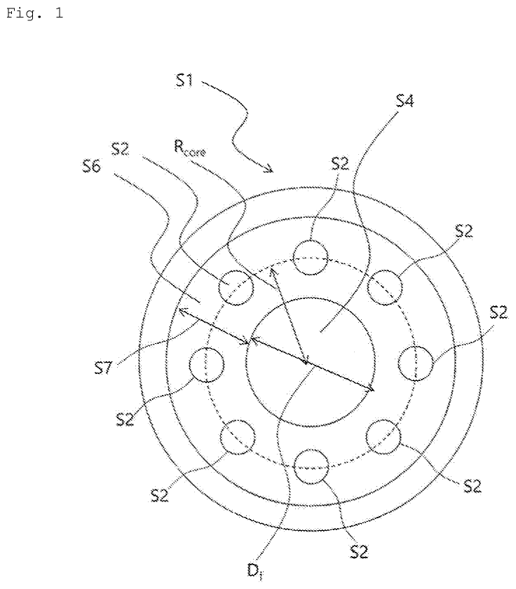

FIG. 1 is a schematic diagram illustrating a cross-sectional structure of a ferrule S1 according to an embodiment of the present disclosure. The ferrule S1 has a cylindrical shape, and through holes for holding the plurality of optical fibers S2 are formed parallel to the longitudinal direction of the cylindrical shape. FIG. 1 illustrates a state in which the optical fiber S2 is held in each through hole. The core centers of the plurality of optical fibers S2 are disposed on the circumference of a circle having a core placement radius R_{core} with respect to the cylindrical center axis of the ferrule S1.

In FIG. 1, an example in which eight core optical fibers S2 are disposed at equal intervals is exemplified, but the core centers of a plurality of optical fibers S2 need only be disposed on the circumference of a circle having a core placement radius S3, and it is not limited thereto. In addition, in the present embodiment, although the plurality of optical fibers S2 are disposed on one circumference, the number of circles in which the plurality of optical fibers S2 are disposed may be two or more. The optical fiber S2 is generally formed of quartz glass, but it is not limited to quartz glass as long as an optical fiber is capable of communicating signal light of a communication wavelength band.

In addition, at one end of the ferrule S1 in the longitudinal direction, the plurality of optical fibers S2 are disposed in an annular angle control region S6 disposed outside a ferrule flat surface S4. The ferrule flat surface S4 is disposed on the center axis of the ferrule S1 and is a surface allowing the abutting of two ferrules against each other. In the present embodiment, an example in which the entire region of the ferrule flat surface S4 is a flat end surface parallel to a surface perpendicular to the longitudinal direction of the ferrule S1 is shown. In this way, the ferrule flat surface S4 of the present embodiment illustrates an example in which the center portion with which two ferrules are brought into contact is flat, but the center portion with which two ferrules are brought into contact is not required to be flat, and for example, one of the two ferrules S1 may be formed into a convex shape and the other may be formed into a concave shape with which the convex shape is brought into contact.

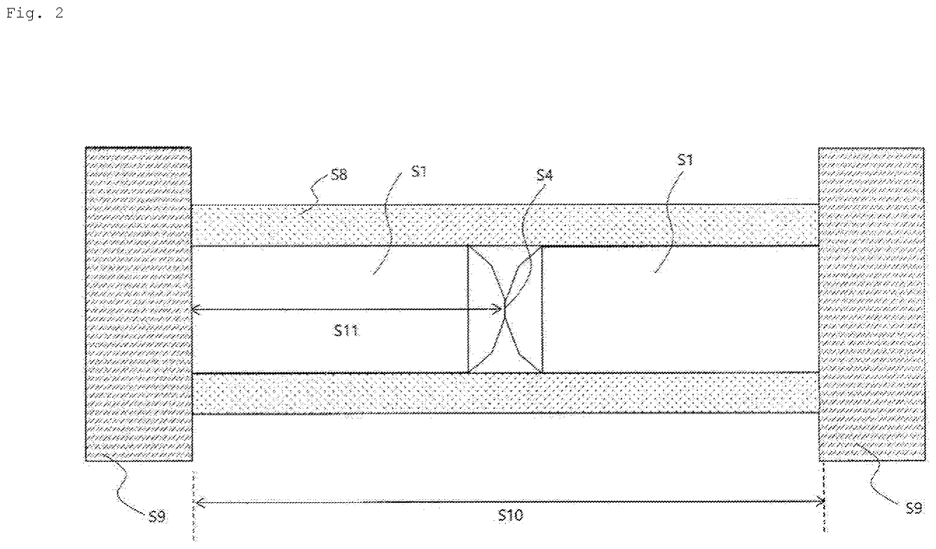

FIG. 2 is a schematic diagram illustrating a side surface of an optical coupling portion according to an embodiment of the present disclosure. The two ferrules S1 into which the optical fibers are inserted are aligned by a sleeve S8 and the axial deviation is controlled to be within a fixed allowable range. In order to minimize the connection loss in the optical coupling portion, it is desirable that each core of the plurality of optical fibers inserted into the two ferrules S1 have the same optical characteristics in that they have almost the same mode field diameter. In addition, the optical fibers inserted into the two ferrules S1 are disposed on a circumference having the same core placement radius on the respective ferrule end surfaces, and it is important to minimize the connection loss due to axial deviation and rotational deviation, and it is desirable to dispose the optical fibers at opposite positions. Further, in order to minimize the connection loss due to the axial deviation as much as possible, it is desirable that the outer diameters of the ferrules of the two ferrules S1 be approximately the same. In addition, it is important that the ferrule flat surfaces of the two ferrules S1 can be brought into contact with each other in order to reduce the excessive loss due to the gap by reducing the gap between the end surfaces of the respective fibers inserted into the two ferrules S1 as much as possible, and it is desirable that a length S10 of the ferrule in the axial direction be approximately the same as or shorter than the total length of the length of the ferrule axial direction of the two ferrules S1.

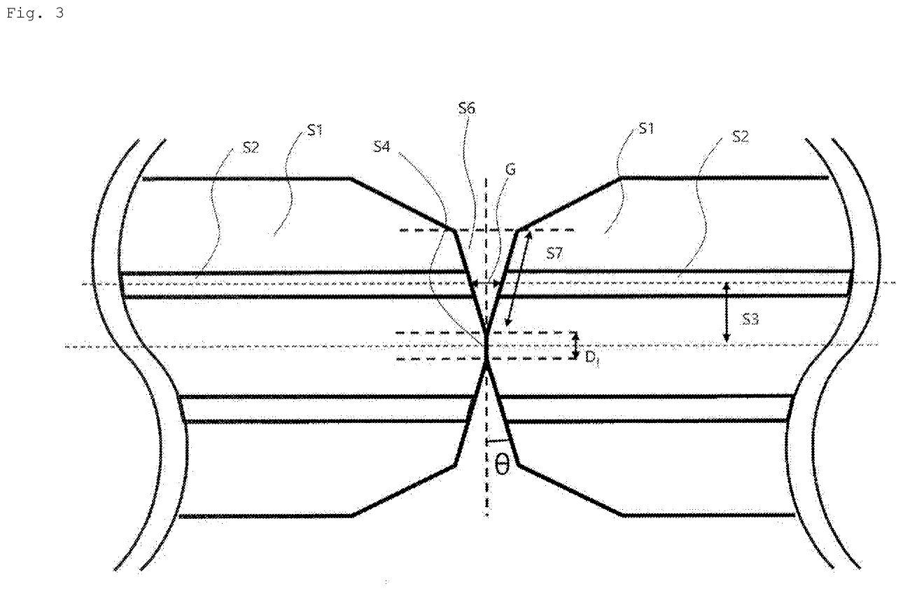

FIG. 3 is a schematic view illustrating the vicinity of the ferrule end surface of the optical coupling portion according to the embodiment of the present disclosure in more detail. The two ferrules S1 are brought into contact with each other on a ferrule flat surface S4 at the center portion of each end surface. The plurality of optical fibers S2 are respectively disposed in an angle control region S6 of the ferrule S1. In order to prevent the respective end faces of the optical fibers S2 from coming into contact with each other and being damaged, the angle control region S6 is inclined to the ferrule flat surface S4, and the angle is controlled in the direction of drawing from the ferrule flat surface S4. In addition, an angle θ of the angle control region S6 with respect to the ferrule flat surface S4 is controlled in order to suppress signal characteristic deterioration due to reflection on an end surface of the optical fiber S2.

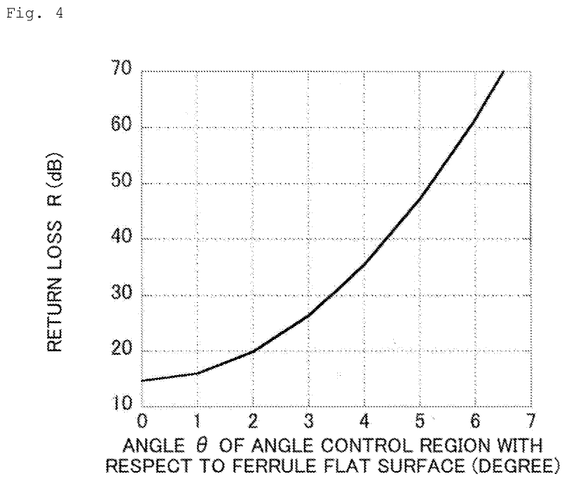

FIG. 4 is a diagram illustrating an example of the relationship between the angle θ of the angle control region with respect to the ferrule flat surface and a return loss R. In optical coupling between optical fibers, if there are regions having different refractive indices between the end faces, the signal characteristics deteriorate by reflection. In the configuration of the optical coupling portion of the present disclosure, there is a gap between the end surfaces of the respective optical fibers S2 inserted into the two ferrules S1, and quartz glass and air have different refractive indices, so that it is necessary to reduce reflection. In the present disclosure, the reflection is reduced by controlling the angle θ of the angle control region S6. The relationship between the angle of the angle control region with respect to the ferrule flat surface θ (unit: degree) and the return loss R (unit: dB) can be expressed by the following expression.

$$[ Math . 1 ]$$

$$R = 10 \frac{{( π \times {n}_{1} \times {ω}_{1} )}^{2}}{{λ}^{2}} \times log ( e ) \times {( 2 θ )}^{2} + {R}_{0} \qquad ( 1 )$$

Here, n₁, ω₁, and λ are the refractive index of the optical fiber, a mode field radius of the optical fiber core, and the signal wavelength, respectively.

In addition, R₀ is the return loss in the case of θ=0 degree, and it can be expressed by the following expression.

$$[ Math . 2 ]$$

$${R}_{0} = - 10 \cdot log [ {( \frac{{n}_{1} - {n}_{2}}{{n}_{1} + {n}_{2}} )}^{2} ] \qquad ( 2 )$$

Here, n2 is the refractive index of a light receiving medium. In the present embodiment, in a case where the wavelength λ is 1,310 nm and the mode field radius ω₁ is 4.5 μm, the return loss R₀ at θ=0 is 14.7 dB, and the angle θ of the angle control region with respect to the ferrule flat surface S4 is set at 5 degrees or more, so that the return loss R of equal to or more than 40 dB can be held.

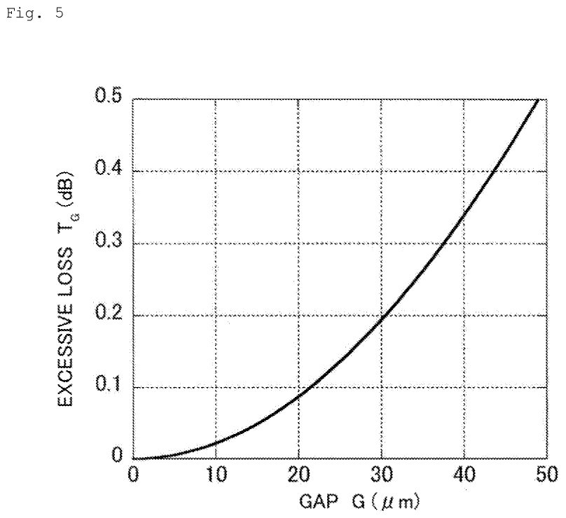

FIG. 5 is a diagram illustrating an example of the relationship of the excessive loss T_{G} with respect to the gap G of the optical fiber. In optical coupling between optical fibers, if there is a gap between the fiber end faces, the distribution of the outgoing light of the input side optical fiber is widened, and the coupling efficiency with the core of the output side optical fiber is reduced, which causes excessive loss. The relationship between the gap G (unit: μm) and the excessive loss T_{G} (unit: dB) can be expressed by the following expression.

$$[ Math . 3 ]$$

$${T}_{G} = \frac{4 [ 4 {G}^{2} + \frac{{w}_{1}^{2}}{{w}_{2}^{2}} ]}{{[ 4 {G}^{2} + \frac{{w}_{2}^{2} + {w}_{1}^{2}}{{w}_{2}^{2}} ]}^{2} + 4 {G}^{2} + \frac{{w}_{2}^{2}}{{w}_{1}^{2}}} \qquad ( 3 )$$

Here, w₁ and w₂ are the mode field radii of the input side and output side optical fiber cores, respectively, and FIG. 5 is a diagram illustrating the loss when the mode field radii of the cores of the respective optical fibers inserted into the two ferrules are 4.5 μm. For example, by adjusting the gap between the end surfaces of the respective optical fibers inserted into the two ferrules so as to be 20 equal to or less than μm, the excessive loss can be suppressed to equal to or less than 0.1 dB.

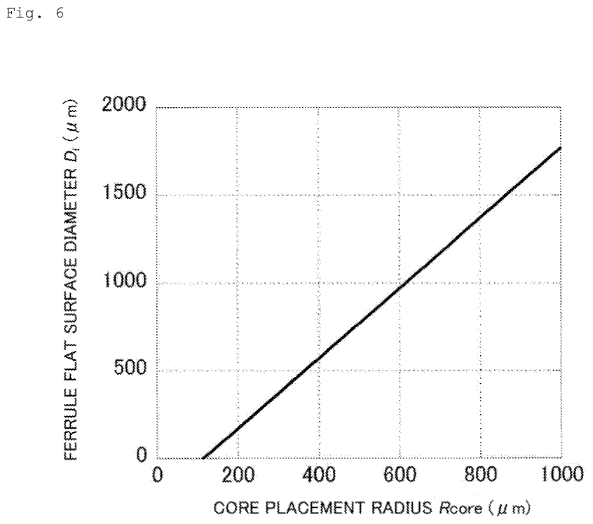

FIG. 6 is a view illustrating an example of the relationship between a diameter D_{f} of the ferrule flat surface with respect to the core placement radius R_{core}. In the configuration of the optical coupling portion of the present disclosure, the relationship between the core placement radius R_{core} (unit: μm) and ferrule flat surface diameter D_{f} (unit: μ437>m) can be expressed by the following expression using the gap G between the end surfaces of the optical fibers inserted into the two ferrules and the angle θ of the angle control region.

$$[ Math . 4 ]$$

$${D}_{f} = [ {R}_{core} - \frac{G}{2} \times \frac{1}{tan ( \frac{θ \times π}{180} )} ] \times 2 \qquad ( 4 )$$

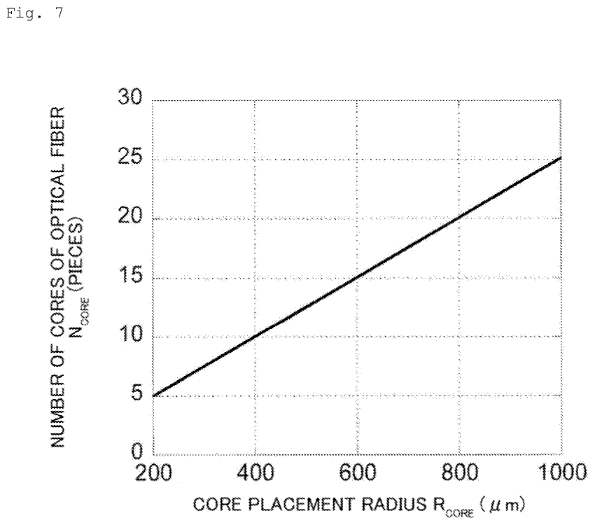

FIG. 6 is a view illustrating the diameter D_{f} of the ferrule flat surface when the gap G and the angle θ of the angle control region are 20 μm and 5 degrees, respectively. In addition, FIG. 7 is a diagram illustrating an example of the relationship between the core placement radius R_{core} and the number of cores N_{core} of the optical fiber of the output side ferrule. FIG. 7 illustrates an example of the number of cores of the optical fiber when the optical fibers are disposed at equal intervals in an annular ring on the core placement radius and the inter core distance between the adjacent optical fibers is 250 μm.

For example, by disposing the optical fibers at equal intervals so that the diameter D_{f} of the ferrule flat surface is about 1800 μm and the core placement radius R_{core} is 1,000 μm and the distance between the adjacent cores is 250 μm, the collective connection of 25 optical fibers can be performed with an excessive loss of equal to or less than 0.01 dB. Further, by disposing the optical fibers at equal intervals so that the distance between adjacent cores is 250 μm with the diameter D_{f} of the ferrule flat surface of about 170 μm and the core placement radius R_{core} of 200 μm, the collective connection of five optical fibers can be performed with an excessive loss of 0 1 dB or less. By setting the diameter D_{f} of the ferrule flat surface to equal to or more than about 170 μm and equal to or less than about 1,800 μm and the core placement radius R_{core} to equal to more than 200 μm and equal to or less than 1,000 μm, the collective connection of equal to more than 5 and equal to or less than 25 optical fibers can be performed with an excessive loss of equal to or less than 0.1 dB.

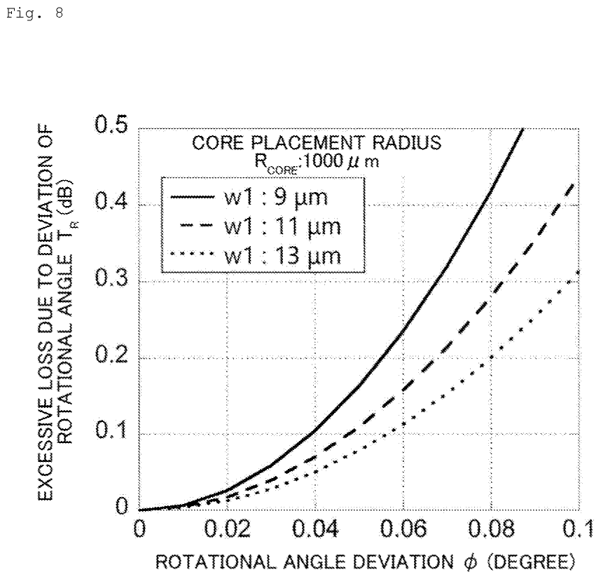

FIG. 8 is a diagram illustrating an example of the relationship between the rotational angle deviation Φ and the excessive loss T_{R} due to the rotational angle deviation. In the configuration of the optical coupling portion of the present disclosure, the rotational angle deviation during manufacturing the optical connector causes excessive loss. In a case where the excessive loss due to a rotational angle deviation is set as T_{R} (unit: dB), a rotational angle deviation is set as Φ unit (unit: degree), and a core placement radius R_{core} (unit: μm), these relationships can be expressed by the following expression.

$$[ Math . 5 ]$$

$${T}_{R} = {( \frac{2 {w}_{1} {w}_{2}}{{w}_{1}^{2} + {w}_{2}^{2}} )}^{2} exp [ 1 \frac{2 {( 2 {R}_{core} sin 2 π \frac{Φ}{360} )}^{2}}{{w}_{1}^{2} + {w}_{2}^{2}} ] \qquad ( 5 )$$

Here, w₁ and w₂ are the mode field radii of the optical fiber core, respectively. FIG. 8 illustrates an example when the core placement radius R_{core} is 1000 μm. As the rotational angle deviation Φ is larger, the excessive loss T_{R} becomes larger, and the connection characteristics deteriorates. FIG. 8 illustrates examples of mode field radii w₁ of 9 μm, 11 μm, and 13 μm. As is apparent from these comparison, using an optical fiber having a larger mode field radius w₁, excessive loss due to deviation of the rotational angle can be reduced compared with a fiber having a smaller mode field radius.

According to the present disclosure, since the end surface of the optical fiber arranged in the cylindrical multi-core ferrule is formed in an oblique shape, excellent reflection characteristics can be achieved. Further, since the shaft is adjusted by the ferrule and the sleeve, excessive loss due to axial deviation can be reduced. Furthermore, in an optical connector using the cylindrical multi-core ferrule of the present disclosure, since one ferrule is provided with a mechanism for controlling rotation and fixation, incident light from an optical fiber facing each other becomes maximum during manufacturing of the connector, that is, since the shaft rotation can be fixed at a position where the connection loss becomes minimum, an optical connector in which excessive loss due to rotation deviation is reduced can be realized.

### Embodiment 1

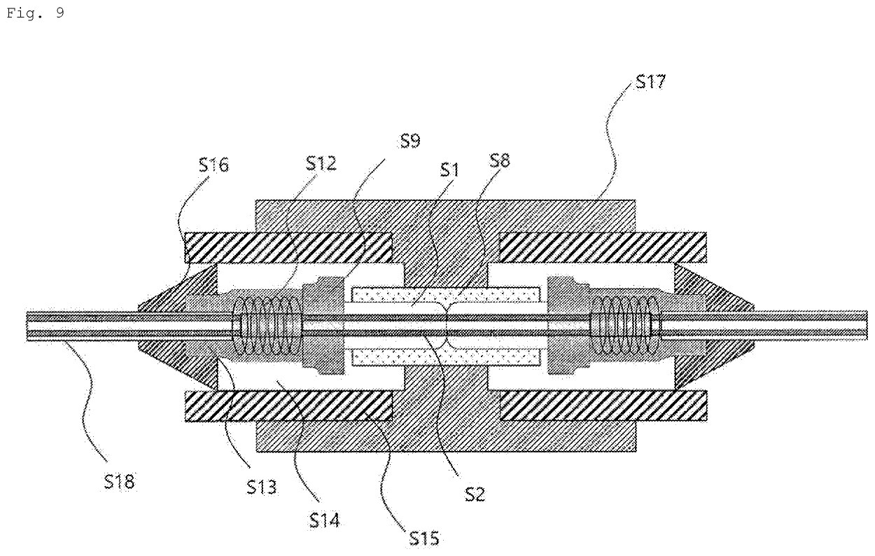

FIG. 9 is a schematic view illustrating a fitting form of an optical coupling portion in an optical connector according to a first embodiment of the present disclosure. The two ferrules S1 are inserted into the sleeve S8 so as to face each other, and pressed by a spring S12 to bring the ferrule flat surfaces of the two ferrules S1 into contact with each other, and thereby the optical fibers S2 are connected in a state having a gap between the end surfaces of the optical fibers S2. In order to facilitate attachment and detachment in connection, the sleeve S8 is built in an adapter S17, and the two ferrules S1 are built in a plug frame S14 attached to the housing S15, respectively.

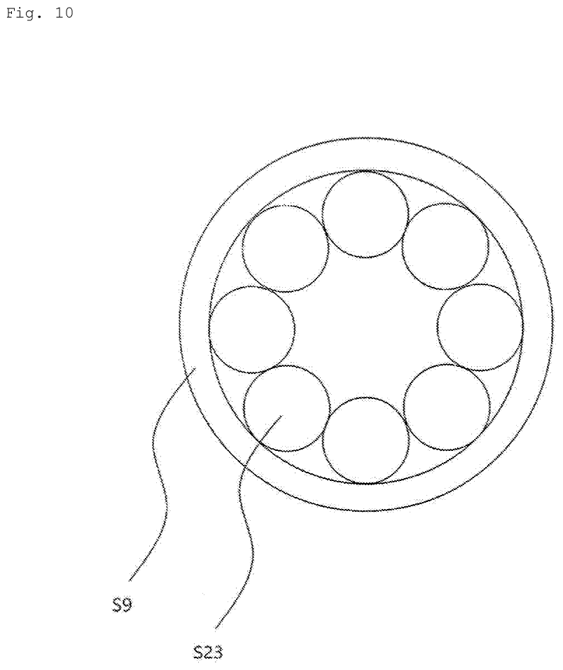

Flanges S9 for protecting the optical fibers S2 are attached to the two ferrules S1. As illustrated in FIG. 10, a plurality of capillaries S23 are inserted into the flange S9 and disposed at the same position as the through hole for holding the optical fiber, so that the optical fiber can be easily inserted into the ferrule.

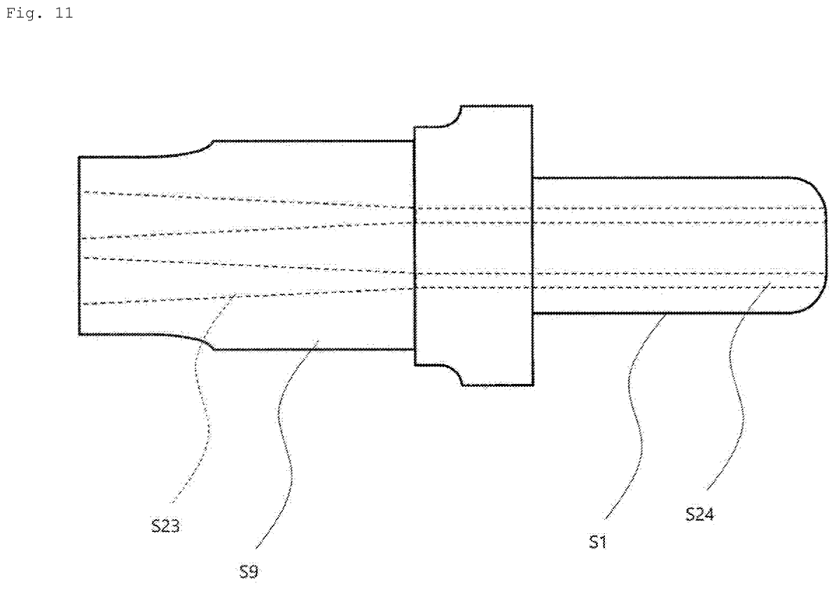

Further, as illustrated in FIG. 11, the capillary S23 is tapered in the longitudinal direction, and the diameter of the tip is made close to the diameter of a through hole S24 for holding the optical fiber, thereby preventing the optical fiber from being caught by a step when the optical fiber is inserted into the ferrule S1. Further, the optical fiber can be prevented from being broken.

In the present embodiment, an example in which a plurality of capillaries S23 are inserted into the flange S9 is illustrated, but it is not limited to this shape as long as the optical fiber can be inserted into the through hole of the ferrule S1 and the optical fiber can be protected when the optical connector is manufactured.

The flange S9 attached to one ferrule of the two ferrules S1 is made to be a notch (not illustrated), and the notch of the flange S9 is fixed in axial rotation by a guide of the notch provided in the plug frame S14. The other ferrule S1 is fitted with a mechanism (not illustrated) capable of rotating and fixing inside the plug frame S14.

When manufacturing an optical connector, that is, when connecting optical fibers, a low-loss optical connector can be manufactured by inserting a housing (connector plug) containing a ferrule with a notched flange on one side of the adapter, inserting a housing (connector plug) attached with a ferrule that can be rotated and fixed inside the plug frame on the other side, attaching devices (for example, a light source and a receiver) that enable transmission and reception to each optical fiber to rotate the ferrule while monitoring the optical signal, and fixing the axial rotation of the ferrule at the point where the received light power becomes maximum.

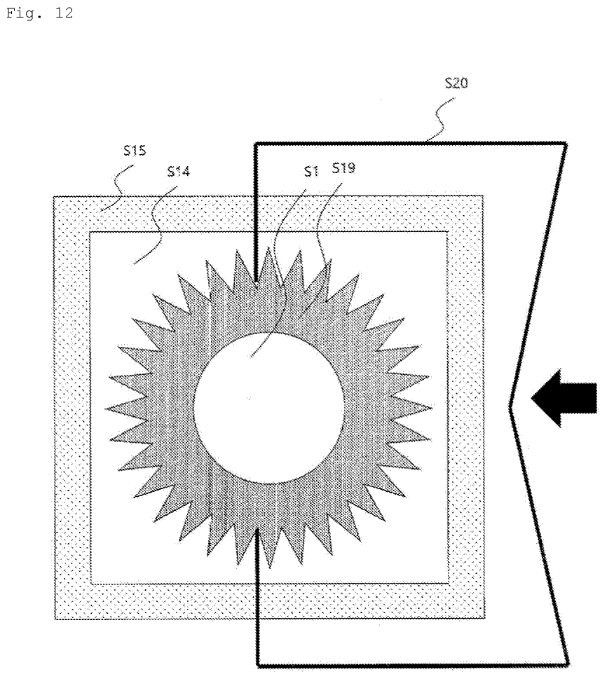

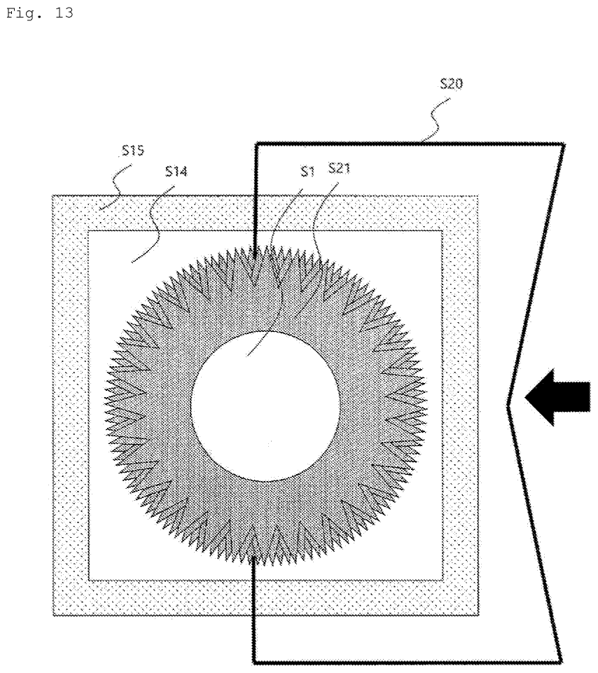

FIG. 12 is a view illustrating an example of a mechanism capable of rotating and fixing a ferrule according to the first embodiment of the present disclosure inside a plug frame. FIG. 12 is a cross-sectional view of a connector plug to which a mechanism capable of rotating and fixing the ferrule S1 inside the plug frame S14 is attached. A grooved flange S19 is attached to the ferrule S1, and a fixed spring S20 is attached to the groove in such a shape that the tip is held in the groove. By pressing the fixed spring S20 in the direction of an arrow in the figure, the tip end of the fixed spring S20 is removed from the groove of the flange S19, and the grooved flange S19 can be axially rotated. By releasing the pressing force of the fixed spring S20 when the monitored light receiving power becomes maximum, the grooved flange S19 is fixed, that is, the ferrule S1 is fixed, and the axial rotation direction of the inserted optical fiber is fixed. For example, as illustrated in FIG. 13, a plurality of annular portions S21 provided with grooves are overlapped and attached to the flange, whereby finer rotational angle control can be performed.

### Embodiment 2

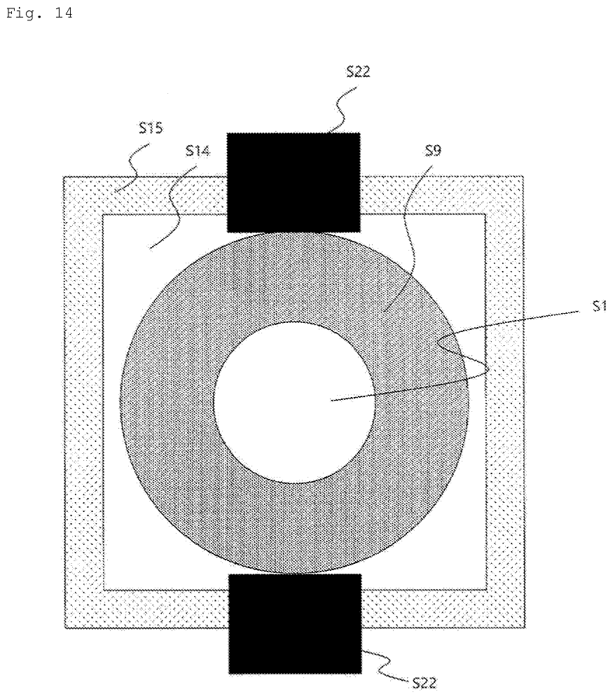

FIG. 14 is a view illustrating an example of a mechanism capable of rotating and fixing a ferrule according to a second embodiment of the present invention inside a plug frame. FIG. 14 is a cross-sectional view of a connector plug to which a mechanism capable of rotating and fixing a ferrule inside a plug frame is attached. The flange S9 is attached to the ferrule S1, and a fixed magnet S22 is attached to the outside of the flange S9. By removing the fixed magnet S22, the flange S9 can be axially rotated, and by attaching the fixed magnet S22 when the monitored light receiving power becomes maximum, the flange S9 is fixed, that is, the ferrule is fixed, and the axial rotation direction of the inserted optical fiber is fixed. Here, the flange S9 may be made of a material having magnetism.

### Effect of Present Disclosure

According to the present disclosure, in an optical coupling portion used for collectively connecting a plurality of ports using a single mode optical fiber, a plurality of single-core fibers are disposed in a cylindrical multi-core ferrule, thereby easily achieving connection of a plurality of optical fibers. Here, since a single-core single-mode fiber generally used is used as the optical fiber used in the same manner as an ordinary optical connector, a device such as fan-in and fan-out is not required in wiring between the transmission and reception devices, and thus, simple and economical optical connection can be realized.

Further, since the end surface of the optical fiber disposed in the cylindrical multi-core ferrule is formed in an oblique shape, excellent reflection characteristics can be realized. Further, since the shaft is adjusted by the ferrule and the sleeve, the excessive loss due to the shaft deviation can be reduced. Furthermore, in an optical connector using the cylindrical multi-core ferrule of the present disclosure, since one ferrule is provided with a mechanism for controlling rotation and fixation, incident light from an optical fiber facing each other becomes maximum during manufacturing of the connector, that is, since the shaft rotation can be fixed at a position where the connection loss becomes minimum, an effect of reducing excessive loss due to rotation deviation can be obtained.

### INDUSTRIAL APPLICABILITY

Since as the connection technology for collectively connecting multiple ports by optical fiber, the cylindrical multi-core ferrule and the optical connector according to the present disclosure use a single-core single-mode fiber generally used is used in the same manner as an ordinary optical connector, a device such as fan-in and fan-out is not required in wiring between the transmission and reception devices, and thus, simple and economical optical connection can be realized. Further, since the end surface of the optical fiber disposed in the cylindrical multi-core ferrule is formed in an oblique shape, excellent reflection characteristics are provided, and excellent optical characteristics are realized in which the excessive loss due to axial deviation is reduced. Furthermore, in the optical connector using the cylindrical multi-core ferrule of the present disclosure, since one ferrule is provided with a mechanism for controlling rotation and fixation, it is possible to provide an optical connector in which excessive loss due to rotation deviation is reduced. As a result, it is possible to use a plurality of single mode optical fibers in an optical fiber network as a technique for collectively connecting them in all facilities.

### REFERENCE SIGNS LIST

S1: Ferrule
S2: Optical fiber
S4: Ferrule flat surface
S6: Angle control region
S7: Angle control region width
S8: Sleeve
S9: Flange
S10: Length in sleeve axial direction
S11: Length in axial direction of ferrule
S12: Spring
S13: Stop ring
S14: Plug frame
S15: Housing
S16: Boot
S17: Adapter
S18: Cord covering
S19: Grooved flange
S20: Fixed spring
S21: Annular portion with groove
S22: Fixed magnet
S23: Capillary
S24: Through hole

1. A cylindrical multi-core ferrule having a cylindrical shape and having through holes formed therein for holding a plurality of optical fibers on the same circle centered on a central axis of the cylindrical shape.

2. The cylindrical multi-core ferrule according to claim 1, wherein a region in which the through hole is disposed at one end in a longitudinal direction of the cylindrical multi-core ferrule is inclined with respect to a plane perpendicular to the longitudinal direction of the cylindrical multi-core ferrule.

3. The cylindrical multi-core ferrule according to claim 2, wherein the inclination of the cylindrical multi-core ferrule with respect to a plane perpendicular to the longitudinal direction thereof is at an angle of 5 degrees or more.

4. The cylindrical multi-core ferrule according to claim 1, wherein the cylindrical multi-core ferrule includes a flat end surface disposed at one end of the cylindrical multi-core ferrule in a longitudinal direction, the flat end surface constituting a surface perpendicular to the longitudinal direction of the cylindrical multi-core ferrule.

5. The cylindrical multi-core ferrule according to claim 4, wherein the flat end surface of the cylindrical multi-core ferrule is disposed on a central axis of the cylindrical shape.

6. The cylindrical multi-core ferrule according to claim 5, wherein the flat end surface has a diameter of equal to or more than 170 μm and equal to or less than 1,800 μm,
wherein a distance from the central axis of the cylindrical shape to the cores of the plurality of optical fibers is equal to or more than 200 μm and equal to less than 1,000 μm.

7. An optical connector in which the cylindrical multi-core ferrules according to claim 1 are disposed opposite to each other, and
a gap is formed between optical fibers held by the cylindrical multi-core ferrule.

8. The cylindrical multi-core ferrule according to claim 7, wherein the cylindrical multi-core ferrules disposed opposite to each other are in contact with each other at a flat end surface perpendicular to a longitudinal direction of the cylindrical multi-core ferrule, and
at least one of the cylindrical multi-core ferrules disposed opposite to each other is rotatable about a central axis of the cylindrical shape.
